(19) United States
(12) Patent Application Publication
(10) Pub. No.: US 2014/0294158 A1
(43) Pub. Date: Oct. 2, 2014

(54) X-RAY WAVEGUIDE

(71) Applicant: CANON KABUSHIKI KAISHA, Tokyo (JP)

(72) Inventors: Kohei Okamoto, Yokohama-shi (JP); Hirokatsu Miyata, Hadano-shi (JP)

(73) Assignee: CANON KABUSHIKI KAISHA, Tokyo (JP)

(21) Appl. No.: 14/216,132

(22) Filed: Mar. 17, 2014

(30) Foreign Application Priority Data
Mar. 26, 2013 (JP) 2013-063598

(51) Int. Cl. G21K 1/06

(52) U.S. Cl. CPC G21K 1/067
USPC 378/145

(57) ABSTRACT

Provided is an X-ray waveguide including a core and two clads opposing to each other so as to sandwich the core, wherein one of the interfaces between the clad and the core has a periodic relief structure in a direction perpendicular to an opposing direction of the two clads and perpendicular to a guiding direction of an X-ray in the X-ray waveguide.

### BACKGROUND OF THE INVENTION

1. Field of the Invention

The present invention relates to an X-ray waveguide to be used in an X-ray optical system for an X-ray imaging technology, an X-ray exposure technology, or the like.

2. Description of the Related Art

When an electromagnetic wave having a short wavelength of several tens of nm or less is dealt with, a difference in refractive index with respect to the electromagnetic wave between different substances is extremely small, and a total reflection angle and a refraction angle with reference to the interface of substances are therefore extremely small. For this reason, hitherto, in order to control an electromagnetic wave having a short wavelength, a large spatial optical system has been mainly used and is still the mainstream technology. Main components forming the spatial optical system include crystal mirrors or a multilayer mirrors in which materials having different refractive indices are alternately laminated, which have various roles such as beam shaping, spot size conversion, wavelength selection, and the like.

Different from such spatial optical systems, components in X-ray optics such as conventional X-ray guiding tubes, polycapillaries, are used, which confine X-rays therein to propagate. Recently, further studies have been made on X-ray waveguides that confine and propagate electromagnetic waves in the X-ray region in a thin film or a multilayer film for downsizing and improved performance of optical systems. The structure of the most basic X-ray waveguide is a single mode waveguide, in which a core made of sufficiently thin air gap or film is sandwiched by a pair of clad layers. In particular, an X-ray waveguide having a structure for reducing propagation loss has been proposed (Physical Review Letters, Volume 100, 184801 (2008)). In addition, there has been proposed an X-ray waveguide consisting of multiple fundamental two-dimensional X-ray waveguides, which can realize a two-dimensional guiding mode by restricting the core widths in the two-dimensional directions (Journal of Applied Physics, Volume 101, Issue 5, 054306 (2007)).

However, the X-ray waveguides proposed in the related-art documents have the following problems.

The related-art single mode waveguide proposed in Physical Review Letters, Volume 100, 184801 (2008) can form a waveguide mode that is controlled only in a one-dimensional direction perpendicular to the guiding direction, but a waveguide mode in the direction parallel to the interface between the core and the clad is not controlled, and hence the waveguide mode in this direction becomes a multiple mode. Further, in the X-ray waveguide having the structure proposed in Journal of Applied Physics, Volume 101, Issue 5, 054306 (2007), in which the individual two-dimensional X-ray waveguides for confining the X-ray in the two-dimensional direction perpendicular to the guiding direction are arranged, the X-ray is confined by total reflection in each two-dimensional X-ray waveguide so that multiple independent waveguide modes are formed. Therefore, it is difficult to form a coherent waveguide mode over the all arranged X-ray waveguides.

In this way, it is difficult for the related-art X-ray waveguides to form a waveguide mode controlled in a two-dimensional direction having a coherency over a broad region perpendicular to the guiding direction.

### SUMMARY OF THE INVENTION

Therefore, the present invention provides an X-ray waveguide having a core with large widths, which forms an X-ray beam with high two-dimensional spatial coherency, whose guiding mode is controlled in the two-dimensional directions.

In order to solve the problems described above, according to an embodiment of the present invention, there is provided an X-ray waveguide, consisting of a core, and a pair of clads opposing to each other to sandwich the core, in which the interface between one of the two clads and the core has a periodic relief structure in a direction perpendicular to the opposing direction of the two clads and perpendicular to the guiding direction of X-rays in the X-ray waveguide.

Further features of the present invention will become apparent from the following description of exemplary embodiments with reference to the attached drawings.

### BRIEF DESCRIPTION OF THE DRAWINGS

FIGS. 1A and 1B are diagrams schematically illustrating features of an X-ray waveguide according to an embodiment of the present invention and the prior art, respectively.

FIG. 2 is a diagram illustrating a core with a periodic structure used in the X-ray waveguide according to an embodiment of the present invention.

FIG. 3 is a diagram illustrating a wave number vector of a waveguide mode according to an embodiment of the present invention.

FIG. 4 is a diagram illustrating structures of a core and clads in the X-ray waveguide according to an embodiment of the present invention.

FIGS. 5A and 5B are diagrams illustrating an X-ray waveguide according to Example 1 of the present invention.

FIGS. 6A and 6B are diagrams illustrating an X-ray waveguide according to Example 2 of the present invention.

FIGS. 7A and 7B are diagrams illustrating an X-ray waveguide according to Example 3 of the present invention.

FIG. 8 is a diagram illustrating an example of a case where the maximum variation of the core width greatly deviates from either a natural-number multiple or a half-integer multiple of a period in an opposing direction of the clads.

### DESCRIPTION OF THE EMBODIMENTS

Now, with reference to the drawings, a structure of an X-ray waveguide according to an exemplary embodiment of the present invention is described. However, the structure and the like described in this embodiment are not intended to limit the scope of the present invention unless otherwise noted.

The X-ray waveguide according to this embodiment includes a core, and two clads opposing to each other so as to sandwich the core. One of the interfaces between the clad and the core has a periodic relief structure in a direction perpendicular to the opposing direction of the two clads and perpendicular to the guiding direction of X-rays in the X-ray waveguide. In other words, in the X-ray waveguide consisting of the core and the two clads opposing to each other to sandwich the core, one of the interfaces between the clad and the core has a regular relief structure in a direction perpendicular to the opposing direction of the two clads, and the guiding direction of X-rays in the waveguide is perpendicular to both the opposing direction and the direction along which the periodicity of the regular relief structure is minimum.

The term “X-ray” used in this embodiment and the present invention refers to an electromagnetic wave in such a wavelength band that the real part of the refractive index of a substance is 1 or less. Specifically, the term “X-ray” refers to an electromagnetic wave having a wavelength of 100 nm or less including extreme ultraviolet (EUV) light. It is known that the frequency of the electromagnetic wave having such a short wavelength is too high for electrons in the outermost shells of atoms in a substance to respond, and hence the real part of the refractive index of a substance becomes smaller than 1, unlike the frequency band of electromagnetic waves whose wavelength is longer than that of light in the ultraviolet region (visible light or infrared light). As expressed in the following expression (1), such a refractive index n of a substance for X-rays is generally represented by using δ, a deviation of the real part of a refractive index from 1, and the imaginary part β′ related to attenuation of the X-ray in the substance.

n=1−δ−iβ′=n′−iβ′ (1)

In many cases, this attenuation can be considered as absorption of the X-ray in the substance. Because δ is proportional to an electron density ρₑ of the substance, the real part n′ of the refractive index decreases as the electron density of the substance increases. In addition, as can be understood from the expression (1), the refractive index real part n′ is expressed by the following expression.

n′=1−δ

Further, ρₑ is proportional to an atomic density ρₐ and an atomic number Z. Therefore, in many cases, two or more types of substances having different refractive index real parts in the present invention means two or more types of substances having different electron densities. In this way, a refractive index of a substance for X-rays is expressed by a complex number. In this specification, a real part thereof is referred to as a refractive index real part while an imaginary part thereof is referred to as a refractive index imaginary part.

Absorption of X-rays in a substance depends on the electron density of the substance. Therefore, when regarding a vacuum state as being filled with a substance having a certain refractive index, the refractive index real part becomes the maximum, i.e. 1. Therefore, vacuum is defined as a substance having a refractive index real part of 1 and a refractive index imaginary part of 0 in the present invention.

In the X-ray waveguide of this embodiment having a structure in which two opposing clads sandwich a core, X-rays are confined in the core by total reflection at the interfaces between the core and the clads so as to form a waveguide mode for propagating the X-rays. The opposing direction of the two clads, namely the direction parallel to a line segment connecting the opposing surfaces of the two clads by the shortest distance is referred to as the opposing direction in the present invention and in this specification.

In order to confine X-rays in the core by total reflection, the X-ray waveguide of the present invention is configured so that the refractive index real part of the substance forming the core is larger than the refractive index real part of the substance forming the clad, at the interfaces between the core and the clad.

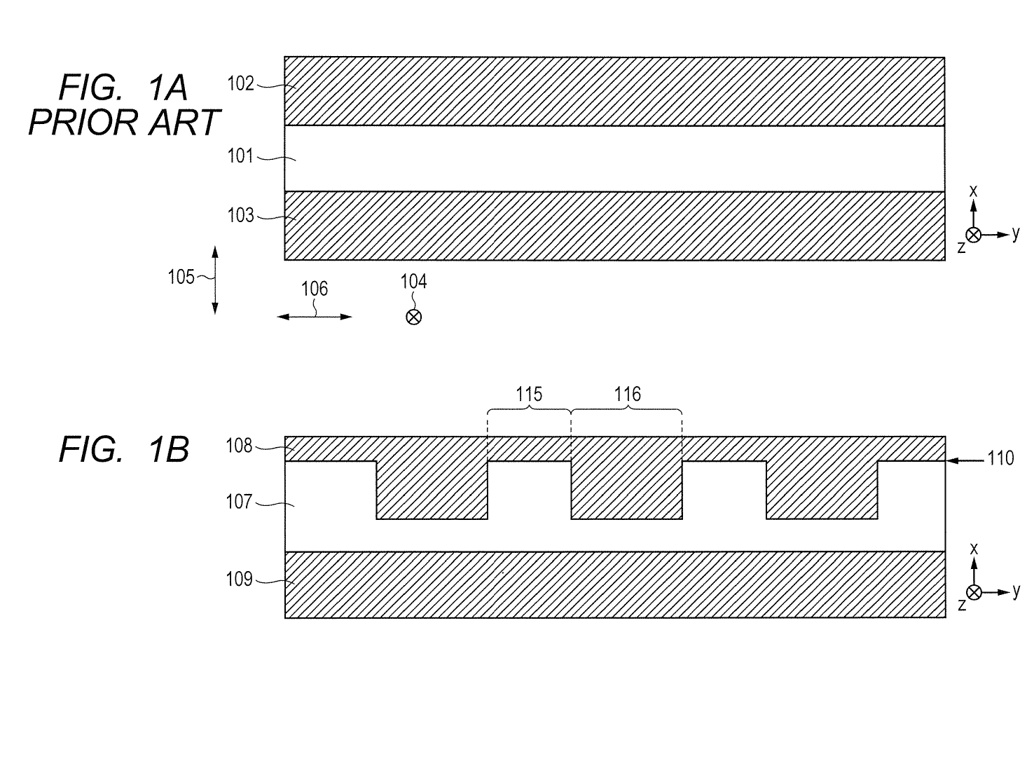

It is supposed that the X-rays on the waveguide mode formed in the X-ray waveguide of this embodiment is guided in one direction perpendicular to the opposing direction, and this direction is referred to as the guiding direction in this specification. The guiding direction is parallel to the direction along which a propagation constant, a wave number vector component in the direction of X-ray guiding, is defined. This guiding direction is defined as the z direction in an orthogonal coordinate system in this specification. In addition, the cross section perpendicular to the guiding direction is referred to as a guiding cross section in the present invention and in this specification. The opposing direction of the clads, the guiding direction of X-rays, and the transverse direction at the interfaces between the core and the clads are briefly described with reference to FIG. 1A.

FIG. 1A illustrates a prior art X-ray waveguide having a structure in which two clads 102 and 103 are disposed to oppose to each other to sandwich a core 101. When the guiding direction is the direction 104, which is perpendicular to the plane of the paper, and the opposing direction of the two clads 102 and 103 is the direction 105, a direction perpendicular to both the guiding direction 104 and the opposing direction 105 can be defined as the transverse direction at the interfaces 106. Further, in this specification, the x direction, the y direction, and the z direction in an orthogonal coordinate system correspond to the opposing direction, the transverse direction, and the guiding direction, respectively.

The X-ray waveguide according to this embodiment consists of two opposing clads that sandwich a core. One of the interfaces between the clads and the core has a periodic relief structure in the direction perpendicular to the opposing direction of the two clads and perpendicular to the guiding direction of the X-rays in the X-ray waveguide. In other words, the X-ray waveguide has a structure in which at least one of the interfaces between the core and the clad has a one-dimensional periodic structure, a regular relief structure, in the transverse direction at the interfaces and perpendicular to the opposing direction, and the guiding direction is perpendicular to both the opposing direction and the transverse direction. Further, the feature “one of the interfaces between the clads and the core has a periodic relief structure in the direction perpendicular to the opposing direction and perpendicular to the guiding direction” includes a concept “the core has multiple periodic grooves on its surface whose periodicity can be defined in the direction parallel to the transverse direction at the interfaces”.

Here, the transverse direction is the direction perpendicular to the guiding direction of X-rays and perpendicular to the opposing direction, as described above. The X-ray waveguide in this embodiment has one-dimensional periodic structure, which is a periodic (regular) relief structure, in the transverse direction at the interfaces. In other words, when the guiding direction is defined as one direction, at least one of the interfaces between the core and the clad has a one-dimensional periodic structure in the transverse direction at the interfaces. Here, it is to be understood that the description “at least one of the interfaces between the core and the clad” may include one of the two interfaces between the core and the clad or may include both of the interfaces.

FIG. 1B is a schematic diagram illustrating an example in which one of the interfaces between the core and the clad has a one-dimensional periodic structure in the transverse direction at the interfaces. In FIG. 1B, opposing two clads 108 and 109 sandwich a core 107, and the one of the interfaces 110 and 111 has a one-dimensional periodic relief structure in the transverse direction at the interfaces 106.

Therefore, while the waveguide mode is controlled only in the opposing direction in the prior art X-ray waveguide illustrated in FIG. 1A, in the X-ray waveguide of this embodiment, the waveguide mode is controlled also in the transverse direction in addition to the control in the opposing direction. Thus, it is possible to form a two-dimensional waveguide mode controlled in the two-dimensional direction.

In FIG. 1B, the waveguide mode is different between the region 115 having a large core width and the region 116 having a small core width in the opposing direction. Therefore, it is possible to form a two-dimensional waveguide mode which selectively exists either in the region 115 or 116, by exciting one of the allowed waveguide modes in each region. Because such a waveguide mode locally existing in a part of the guiding cross section is formed by the interference of the X-rays over the entire core, the electromagnetic fields are in phase between the region in which the electromagnetic field is concentrated and the region in which the electromagnetic field is not concentrated.

Because the core of the X-ray waveguide in this embodiment is continuously formed in the transverse direction at the interfaces 106 as illustrated in FIG. 1B, the X-rays confined in the core 107 interfere in the entire transverse direction at the interfaces when they propagate in the guiding direction. Therefore, the two-dimensional waveguide mode can be formed, which is in phase over the entire width along the transverse direction in addition to the width along the opposing direction.

In contrast to this, when the above-mentioned periodic relief structure in the transverse direction at the interfaces is not formed, in other words, when the structure of a waveguide is uniform in the transverse direction and no structures for defining a waveguide mode in the transverse direction is formed, the mode in the transverse direction becomes a complicated multiple mode. As a result, spatial coherency in the transverse direction becomes significantly low.

The period of the periodic relief structure in the transverse direction at the interfaces is preferably 1 nm or more to 10 μm or less.

In addition, when the core is made of a uniform substance for X-rays, in the X-ray waveguide of this embodiment, X-rays are more concentrated in the regions with a larger core width in the guiding cross section, but X-rays exists continuously also in the regions with a smaller core width. The X-rays in the wider core regions adjacent to each other need to cause strong interference by propagating through the real space of the regions with the smaller core width. This regulates the required thickness of the core in the regions with the smaller core width in the opposing direction. It is preferred to satisfy such a relationship that the X-rays locally existing in the region with the larger core width is not attenuated to less than 1/e² of the largest amplitude thereof (e is Napier's constant) in the region with the smaller core width. However, this also depends on the refractive indices of the substances forming the waveguide. Therefore, for instance, it is red that, in the opposing direction, the thickness of the core in the region with a smaller core width be larger than 1/e² of the thickness of the core in the region with the smaller core width. It is also preferred that, in the opposing direction, the thickness of the core in the region with a smaller core width is smaller than (1−1/e²) of the thickness of core in the region with the larger core width. In other words, it is preferred that, in the opposing direction of the core, the thickness of the core in the region with the smaller core width is 1/e² or larger and 1−1/e² or smaller when the thickness of the core in the region with the larger core width is assumed to be 1.

A substance having a small absorption coefficient and a large refractive index real part is preferred as the substance forming the core in order to confine the X-ray in the core by total reflection at the interfaces between the core and the clads. Examples thereof include, but not limited thereto, vacuum, air, a mesoporous material, beryllium (Be), boron (B), carbon (C), boron carbide (B₄C), and boron nitride (BN). In addition, a substance having a small refractive index real part is preferred as a substance forming the clad. Examples thereof include, but not limited to, nickel (Ni), osmium (Os), platinum (Pt), tungsten (W), and titanium (Ti). In addition, the X-ray waveguide of the present invention is produced by a combination of prior art semiconductor process technologies such as photolithography, electron beam lithography, an etching process, a sputtering process, and a sol-gel process. However, the production method for the X-ray waveguide is not limited thereto.

In addition, it is preferred that the core has a periodic structure wherein the refractive index real part have a periodicity in the opposing direction in which the two clads oppose to each other, and that the Bragg angle determined by the periodicity and the wavelength of the X-rays is smaller than the total reflection critical angle of the X-rays at the interfaces between the core and the clads. The reason of this requirement is described below.

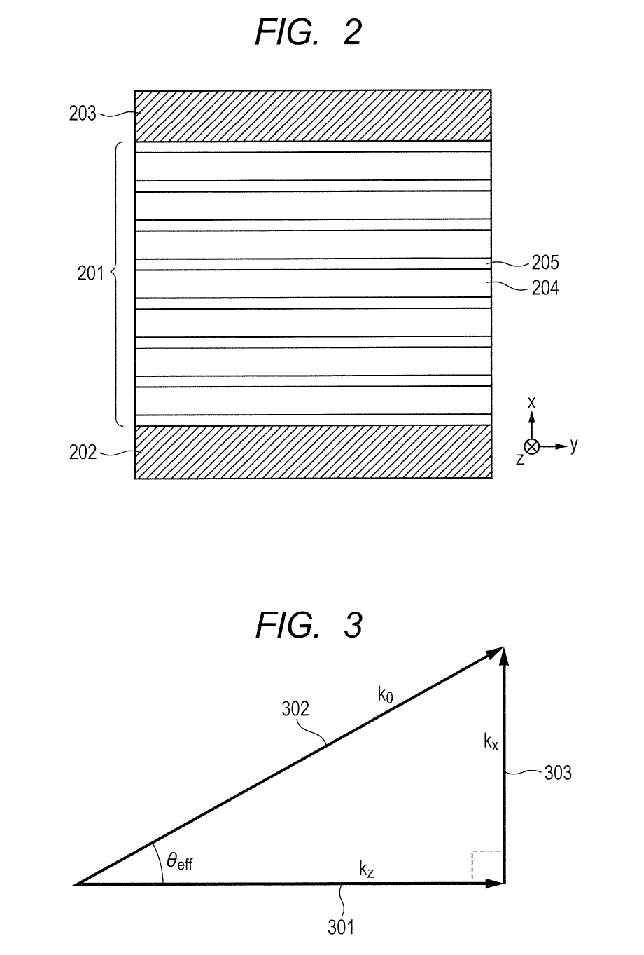

First, a case where the interface between the core and the clad has no periodic structure in the transverse direction (FIG. 2) is described. In FIG. 2, a core 201 is sandwiched by two opposing clads 202 and 203, and the core has a periodic structure in which a substance layer 204 having a large refractive index real part and a substance layer 205 having a small refractive index real part are periodically stacked in the opposing direction. When the core is made of a uniform medium, all the allowable waveguide modes resonate with the core width in the opposing direction. In contrast, when the core has a periodicity in refractive index in the opposing direction, as illustrated in FIG. 2, waveguide modes resonating with both the core width and the periodicity in the opposing direction is formed. In the present invention and this embodiment, this waveguide mode is referred to as a periodicity resonant waveguide mode. Here, the propagation angle θ_{eff} of the fundamental wave in the waveguide mode is defined as the angle from the guiding direction in the plane perpendicular to the transverse direction. When a waveguide mode is approximated as being formed by interference upon propagation of one plane wave which repeats total reflection at the interfaces between the core and the clads, the fundamental wave represents the said one plane wave. When a vector 301, which shows a component parallel to the guiding direction of the wave number vector in the waveguide mode, is expressed by k_{z}=(0, 0, k_{z}) as illustrated in FIG. 3, the fundamental wave is defined as a plane wave having a wave number vector 302 of k₀ in vacuum. In this case, the angle between the wave number vector k₀ and the wave number vector k_{z} is referred to as an effective propagation angle θ_{eff}, and the wave number vectors and the effective propagation angle θ_{eff} are associated to each other by the following expression (2). The wave number vector 303, expressed as kₓ=(kₓ, 0, 0), is a vector representing a component of the wave number vector in the opposing direction.

θ_{eff}=arccos(|k_{z}|/|k₀|) (2)

The waveguide modes formed in the waveguide have different effective propagation angles depending on the orders thereof. Because the periodicity resonant waveguide mode is a waveguide mode that strongly resonates with the periodicity of the periodic structure of the core, the corresponding effective propagation angle becomes the angle close to the Bragg angle determined by the periodicity of the periodic structure and the wavelength of the X-ray. An actual Bragg angle have a finite width, referred to as the Bragg angle range, but the Bragg angle in the present invention expresses the effective propagation angle of the fundamental wave in the periodicity resonant waveguide mode and represents the minimum angle in the actual Bragg angle range. In addition, the X-ray waveguide of this embodiment is required to confine the fundamental wave propagating with an effective propagation angle defined as the Bragg angle in the core by total reflection at the interfaces between the core and the clads. Therefore, the X-ray waveguide is configured so that the Bragg angle is smaller than the total reflection critical angle at the interface between the core and the clad. The periodicity resonant waveguide mode is a waveguide mode in which the X-ray resonates with the periodicity of the periodic structure based on the multiple interference caused by repeating partial reflection and refraction at the interfaces in the periodic structure. In addition, in the opposing direction, the electromagnetic field distribution of the periodicity resonant waveguide mode has a periodicity, which is identical to the periodicity of the core in the opposing direction. In this case, the antinodes of the electromagnetic field distribution of the periodicity resonant waveguide mode is located at the positions with the larger refractive index real part, namely the positions with the smaller absorption coefficient of the periodic structure of the core. Therefore, the propagation loss of the periodicity resonant waveguide mode becomes smaller than those of other waveguide modes. Further, because of the periodicity of the core in the opposing direction and the confinement by the total reflection, the periodicity resonant waveguide mode becomes a waveguide mode obtained as a result of the strong distribution feedback action of the X-rays in the periodic structure, that is, becomes a waveguide mode which has such an envelope pattern that the electromagnetic field distribution is concentrated in the core center and suppresses the leakage of the electromagnetic field into the clads. In this way, because the propagation loss in the periodicity resonant waveguide mode is smaller than the propagation losses in other waveguide modes, the periodicity resonant waveguide mode is chosen as a single waveguide mode as a result of propagation in the waveguide for a sufficient length. Those characteristics in the periodicity resonant waveguide mode appear when the X-ray resonates with both the core width in the opposing direction and the periodicity of the periodic structure of the core.

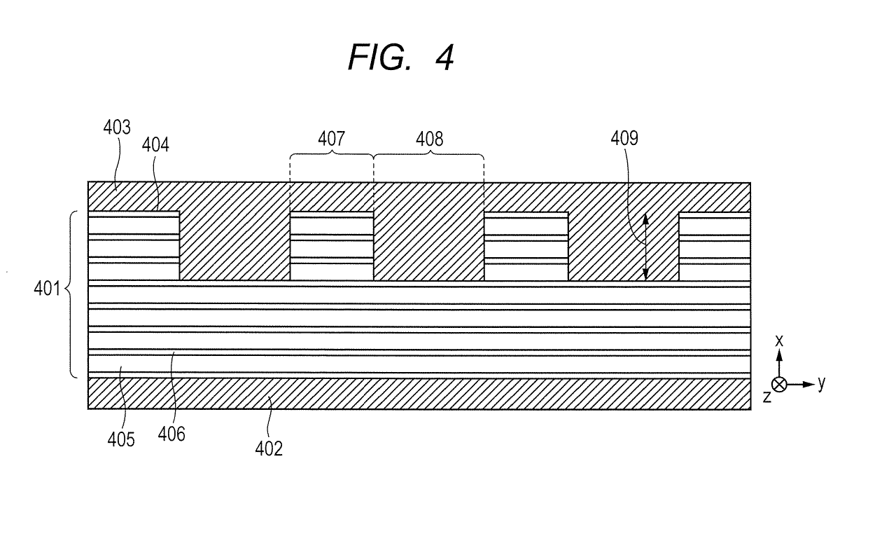

The X-ray waveguide of this embodiment is obtained by introducing, to the X-ray waveguide illustrated in FIG. 2 capable of forming the periodicity resonant waveguide mode described above, a one-dimensional periodic structure, a regular relief structure, at the interface between the core and the clad as illustrated in FIG. 1B, in the transverse direction. The case where the interface between the core and the clad has a one-dimensional periodic structure in the transverse direction is illustrated in FIG. 4. The X-ray waveguide illustrated in FIG. 4 has a structure in which two opposing clads 402 and 403 sandwiching a core 401 with a periodic structure consisting of a substance layer 405 having a large refractive index real part and a substance layer 406 having a small refractive index real part. The interface 404 between the core and the clad, which is in contact with the clad 403, has a relief structure in the transverse direction, which causes a periodic increase and decrease of the core width in the opposing direction. In the opposing direction, a region having a large core width is denoted by reference numeral 407, a region having a small core width is denoted by reference numeral 408, and a largest variation between the widths is denoted by reference numeral 409. Note that, in the example of FIG. 4, the variation is constant.

In the X-ray waveguide having the one-dimensional periodic structure in the transverse direction at the interface between the core and the clad as illustrated in FIG. 4, a two-dimensional periodicity resonant waveguide mode can be formed by the one-dimensional periodic structure in the transverse direction. The two-dimensional periodicity resonant waveguide mode can be formed by configuring the X-ray waveguide of the present invention so that the largest variation of the core width in the opposing direction 409 is a natural-number multiple of the period of the core. The largest variation of the core width in the opposing direction 409 is the difference of the core width caused by the formed periodic structure in the transverse direction. In other words, the largest variation 409 is a distance between a top face and a bottom face of the core, and can be referred to also as a top-to-bottom difference. In this case, the same periodic resonant waveguide mode exists, which can resonate with both the period of the periodic structure and the core width, in both of the regions with a large core width and a small core width in the opposing direction. Therefore, the electromagnetic field of this waveguide mode in the guiding cross section extends in both of the regions with a large core width and a small core width. However, because the core width varies in the guiding cross section, the waveguide mode in this case exhibits an electromagnetic field distribution corresponding to the variation of the core width, and becomes a two-dimensional periodicity resonant waveguide mode, which is controlled in the two-dimensional direction in the guiding cross section. This two-dimensional periodicity resonant waveguide mode is a mode formed as a result of interference of the X-rays over the entire core in the transverse direction and in the opposing direction in the guiding cross section, and hence becomes a mode being in phase in the guiding cross section over the entire core.

In addition, the two-dimensional periodicity resonant waveguide mode can be formed by configuring the X-ray waveguide of this embodiment so that the largest variation 409 is a positive half-integer multiple of the period of the core. In the case where the core width in the opposing direction is varied, configuration of the waveguide in such a manner that a width variation between the regions with a large core width and a small core width is a half-integer multiple causes such a condition that the X-rays can resonate with both the width and the periodicity in one of the regions but the X-rays can resonate with only one of the core width or the periodicity in the other region. In this case, the waveguide mode cannot be formed in the latter region. As a result, there is formed such a two-dimensional periodicity resonant waveguide mode controlled in the two-dimensional direction in the guiding cross section wherein the X-rays localize in the former region. This two-dimensional periodicity resonant waveguide mode is also a mode formed as a result of interference of the X-rays over the entire core in the transverse direction and in the opposing direction in the guiding cross section, and hence becomes a mode being in phase in the guiding cross section over the entire core. Therefore, it is preferred that the largest variation of the core width in the opposing direction in which the clads oppose to each other be a natural-number multiple or a half-integer multiple of the period of the one-dimensional periodic structure of the core.

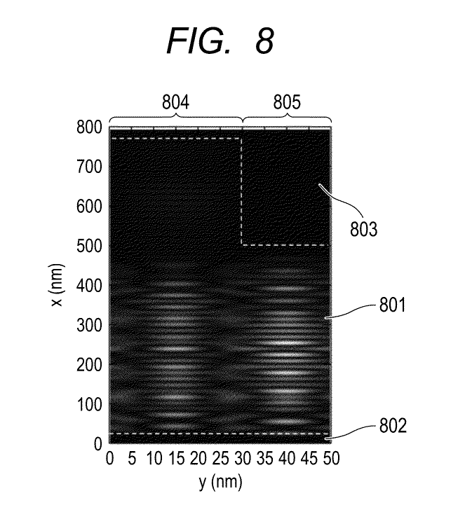

In the case where the core has a periodic structure in the opposing direction, when the largest variation of the core width greatly deviates from a value that is a natural-number multiple or a half-integer multiple of the period in the opposing direction, definite waveguide mode control in the guiding cross section cannot be performed. FIG. 8 is a diagram in the guiding cross section illustrating a state in which the waveguide mode is not clearly controlled in the transverse direction where the largest variation of the width greatly deviates from both a natural-number multiple and a half-integer multiple of the period in the opposing direction. Clads 802 and 803 are made of tungsten, and a core 801 is formed of a periodic multilayer film in which boron carbide (B₄C) having a thickness of 12 nm and aluminum oxide (Al₂O₃) having a thickness of 3 nm are alternately stacked. The number of the period of the core in a region 804 having a wide core is 50, and the number of the period of the core in a region 805 having a narrow core is approximately 29.75. Therefore, the largest variation of the core width corresponds to 20.25 periods, which is neither a natural-number multiple nor a half-integer multiple of the period of the core in the opposing direction. In FIG. 8, a white dotted line indicates an interface between the core and the clad, but the interfaces between the layers in the periodic structure forming the core is omitted to clarify the diagram. In FIG. 8, the bright parts correspond to the parts having high electric field intensity of the X-ray, and the dark parts correspond to the part having low electric field intensity thereof. It is understood from FIG. 8 that the waveguide mode in the guiding cross section is not clearly controlled due to periodicity in the transverse direction and becomes a complicated one.

In addition, when the core has a periodic structure in the opposing direction, it is preferred that the largest variation of the core width be one or more periods of the core in the opposing direction, and that the thickness in the opposing direction in the region having a smaller core width be one or more periods in the opposing direction. When the core of the X-ray waveguide of this embodiment consists of a periodic structure in the opposing direction, the X-ray waveguide of the present invention can be constructed by using a periodic multilayer film as the periodic core. From a viewpoint of sufficiently extracting a multiple interference effect in the periodic multilayer film, it is preferred that the number of the period of the periodic multilayer film be 20 or larger. In addition, in order to confine the X-rays on the resonance mode in the periodic multilayer film by total reflection at the interface between the core and the clads, the periodic multilayer film is formed so that the Bragg angle, which is determined by the wavelength of the X-ray and periodicity of the periodic multilayer film, is smaller than the total reflection critical angle at the interface between the core and the clad. The periodic multilayer film is a film having a structure obtained by periodically stacking multiple substances having different refractive index real parts. For example, beryllium (Be), boron (B), boron carbide (B₄C), carbon (C), and boron nitride (BN) are given as a material having a large refractive index real part, and for example, aluminum oxide (Al₂O₃), silicon carbide (SiC), silicon nitride (Si₃N₄), and magnesium oxide (MgO) are given as a material having a small refractive index real part. However, examples thereof are not limited to these materials. For instance, when the periodic multilayer film is made of B₄C and Al₂O₃ that are alternately stacked, the clad is made of W, and the photon energy of the X-ray is set to 8 kilo electron volts, it is preferred that the period of the periodic multilayer film be 15 nm, but this is not a limitation. In addition, a sputtering method is given as a method of manufacturing the periodic multilayer film.

When the core of the X-ray waveguide of this embodiment is formed of a periodic multilayer film having periodicity in the opposing direction, the X-ray waveguide of the present invention can be configured by using a mesostructured materials having a lamellar structure as the periodic multilayer film. The above-mentioned condition is applied also for the period and the number of period of the periodic multilayer film consisting of a mesostructured materials having a lamellar structure. The mesostructured materials having a lamellar structure has a one-dimensional periodic structure formed by self-assembly of amphiphilic molecules. Such a mesostructured materials have a structure in which an oxide such as silica, tin oxide, and titanium oxide and an organic substance are alternately stacked, and can be manufactured by a sol-gel method or the like.

In addition, when the core of the X-ray waveguide of this embodiment is formed using a material with a periodic structure having periodicity in the opposing direction, the material with a periodicity is not limited to a lamellar structure. It is possible to use, as the material with a periodic structure, mesostructured materials as represented by mesoporous materials in which hollow pores or assembly of an organic molecules are periodically arranged in the guiding cross section in an oxide material. In particular, a mesostructured materials having a two-dimensional structural regularity in the plane perpendicular to the guiding direction is preferably used. In this case, the mesostructured materials having a two-dimensional structural regularity can be considered to have a one-dimensional periodic structure in which the average refractive index periodically changes in the opposing direction, and hence can be preferably used as the materials with a periodic structure forming the core of the X-ray waveguide of the present invention.

In particular, as to the mesostructure body, a mesoporous material in which the assembly of the organic molecules is removed is preferably used as the material with s periodic structure. Because such mesoporous materials have a hollow structure, the absorption loss of the X-ray can be reduced. In order to suppress attenuation of the X-ray, orientation of those pores may be controlled. As described above, in this specification, air and vacuum are also included in the concept of “substance”. Therefore, even when the part of the hole in the mesoporous materials is air or vacuum, the mesoporous materials have portions having different refractive indexes, and hence can be referred to as the mesostructured materials including multiple substances.

A method of preparing the mesostructured materials in this embodiment is not particularly limited, but the mesostructured materials is prepared by, for example, adding an inorganic oxide precursor to a solution of an amphiphilic substance (surfactant, in particular), which can form molecular assemblies, forming a film, and proceeding the reactions of the inorganic oxide formation.

In addition, it is possible to add an additive for adjusting the period of the structure in addition to the surfactant. This additive for adjusting the period of the structure includes a hydrophobic substance. Examples of the hydrophobic substance include alkanes and an aromatic compound without any hydrophilic group. Octane is a specific example thereof.

Examples of the inorganic oxide precursor include alkoxides and chlorides of silicon or a metal element. Further, specific examples thereof include alkoxides and chlorides of Si, Sn, Zr, Ti, Nb, Ta, Al, W, Hf, or Zn. Examples of the alkoxides include a methoxide, an ethoxide, a propoxide, and an alkoxide in which part thereof is substituted with an alkyl group. For example, a dip coating method, a spin coating method, and a hydrothermal synthesis method are given as a film formation method.

Control of the structure of the mesostructure materials can be performed by appropriately changing materials and process conditions in the above-mentioned production process. In addition, when producing the mesoporous material having a uniaxially-oriented two-dimensional periodic structure, for example, a step of forming a uniaxially-oriented polyimide film or the like obtained by a rubbing process on a substrate is provided as a preprocess of the above-mentioned manufacturing process.

### EXAMPLES

Now referring to the drawings, the present invention is described in detail below by way of examples, but the present invention is not limited only to the examples to be described below.

### Example 1

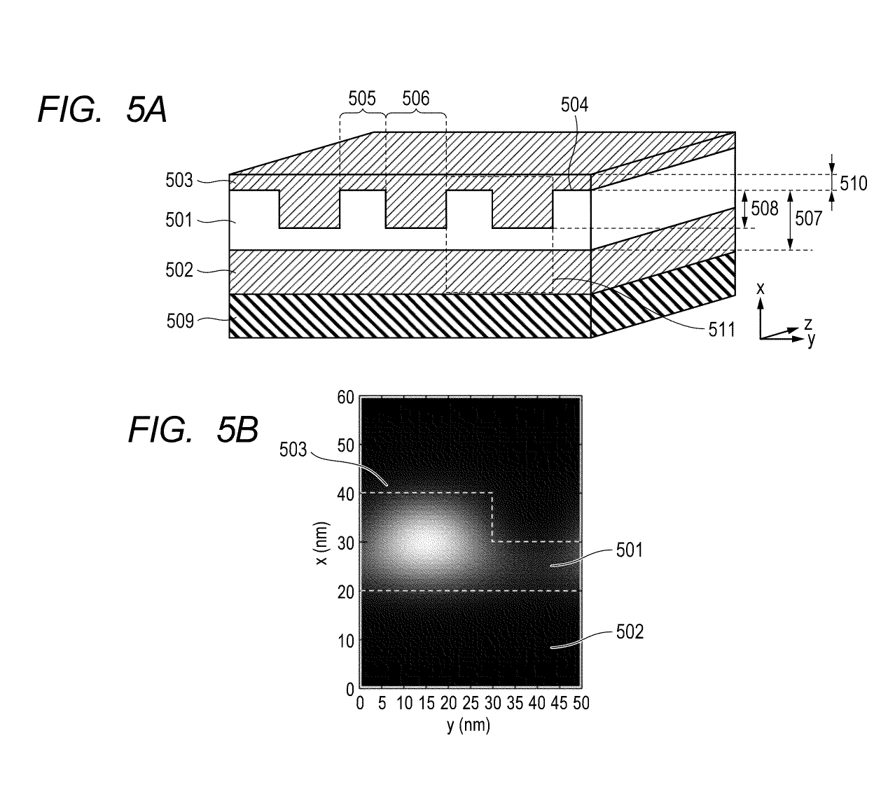

FIG. 5A is a perspective view illustrating an X-ray waveguide according to Example 1 of the present invention. In FIG. 5A, the guiding direction of X-rays is the z direction, the opposing direction is the x direction, and the transverse direction is the y direction. This waveguide has a structure in which a lower clad 502 and an upper clad 503 that are made of nickel (Ni) sandwiching a core 501 made of carbon (C), and is formed on a Si substrate 509. The interface 504 between the core 501 and the upper clad 503 has a one-dimensional periodic structure having a periodic relief in the transverse direction, and hence there are a region 505 having a large core width and a region 506 having a small core width in the opposing direction. The length of the X-ray waveguide of this example in the transverse direction is so large as 10 mm, and hence only a part thereof is illustrated in FIG. 5A. Lengths of the region 505 and the region 506 in the transverse direction are 30 nm and 20 nm, respectively. In addition, in the opposing direction, a core width 507 in the region 505 and a core width 508 in the region 506 are 20 nm and 10 nm, respectively, and a thickness 510 of the upper clad 503 at the region 505 is 20 nm. The X-ray waveguide of this example is obtained by sequentially forming the lower clad 502 made of Ni having a thickness of 20 nm and the core made of C having a thickness of 20 nm on the Si substrate 509 by a sputtering method, forming a periodic relief structure in the transverse direction on the surface of the core by electron beam lithography and a dry etching process, and forming thereon the upper clad 503 made of Ni by sputtering.

FIG. 5B is a graph showing the electric field intensity distribution in the guiding cross section in the waveguide mode formed in the X-ray waveguide of this example, which is obtained by calculation for X-rays having a photon energy of 8 kilo electron volts. The X-ray waveguide of this example has a periodicity in the transverse direction, and therefore, only a region corresponding to a unit lattice thereof, for example a region 511, is shown in FIG. 5B. The white broken lines in FIG. 5B indicate the core-clad boundaries in the waveguide structure in the guiding cross section, and the gradation of white and black indicates the electric field intensity distribution. The whiter part corresponds to the part with higher electric field intensity. It is understood from FIG. 5B that the two-dimensional waveguide mode is formed in which the electric field is concentrated in the region having a larger core width in the opposing direction. The electric field is localized in the guiding cross section. Because this distribution is formed by the interference of the X-rays over the entire core in the opposing direction and in the transverse direction, this waveguide mode are in phase over the entire core in the guiding cross section. By impinging X-rays at an end surface parallel to the guiding cross section of the X-ray waveguide of this example so as to form an incident angle of 0° with respect to the guiding direction in a plane perpendicular to the transverse direction, it is possible to excite a single two-dimensional waveguide mode having the electric field intensity distribution shown in FIG. 5B.

### Example 2

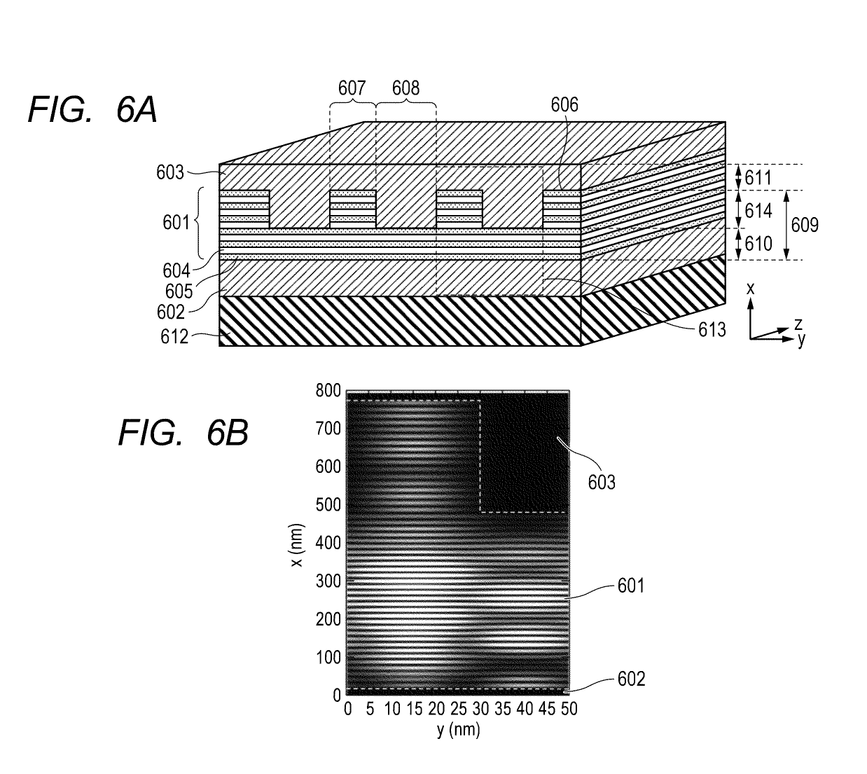

FIG. 6A is a perspective view illustrating an X-ray waveguide according to Example 2 of the present invention. In FIG. 6A, the guiding direction of an X-ray is the z direction, the opposing direction is the x direction, and the transverse direction is the y direction. This waveguide has a structure in which a lower clad 602 and an upper clad 603 that are made of tungsten (W) sandwiching a core 601, and is formed on a Si substrate 612. The interface 606 between the core 601 and the upper clad 603 has a one-dimensional periodic structure having a periodic relief in the transverse direction, and hence there are a region 607 having a large core width and a region 608 having a small core width in the opposing direction. The length of the X-ray waveguide of this example in the interface direction is so large as 10 mm, and hence only a part thereof is illustrated in FIG. 6A. The X-ray waveguide of this example has a structure in which tungsten (W) having a thickness of 20 nm is formed also at the edge in the transverse direction, and hence leakage of the X-rays in the transverse direction is suppressed. The core 601 is a periodic multilayer film in which high refractive index layers 604 that are made of boron carbide (B₄C) as a material having a large refractive index real part and has a thickness of 12 nm and a low refractive index layers 605 that are made of aluminum oxide (Al₂O₃) as a material having a small refractive index real part and has a thickness of 3 nm are alternately periodically stacked. The period of the core 601 is 15 nm. Lengths of the region 607 and the region 608 in the transverse direction are 30 nm and 20 nm, respectively.

In addition, in the opposing direction, a core width 609 in the region 607 corresponds to 50 periods of the periodic multilayer film, and a core width 610 in the region 608 corresponds to 30 periods of the periodic multilayer film. The core layers that contact with the clads are the low refractive index layer 605 at both of the interfaces. As a result, the largest variation 614 of the core width in the opposing direction in the region 607 and the region 608 corresponds to 20 periods of the periodic multilayer film, which is a natural-number multiple of the period. The thickness of the clad 611 at the region 606 is 20 nm. The X-ray waveguide of this example is obtained by forming the lower clad 602 that is made of tungsten (W) and has a thickness of 20 nm on a Si substrate 612 by a sputtering method, stacking a low refractive index layer 605 made of Al₂O₃ and a high refractive index layer 604 made of B₄C alternately for 50 periods, forming a periodic relief structure in the transverse direction on a surface of the core by electron beam lithography and a dry etching process, and forming the upper clad 603 made of W on the periodic relief structure by sputtering.

FIG. 6B is a graph showing the electric field intensity distribution in the guiding cross section in the waveguide mode formed in the X-ray waveguide of this example, which is obtained by calculation for X-rays having a photon energy of 8 kilo electron volts. The X-ray waveguide of this example has periodicity in the transverse direction, and therefore only a region corresponding to a unit lattice thereof, for example, a region 613 is shown in FIG. 6B. The white broken lines in FIG. 6B indicate the core-clad boundaries in the waveguide structure in the guiding cross section, and the gradation of white and black indicates the electric field intensity distribution. Note that, in order to avoid obscurity in the graph, the boundary of the materials in the periodic multilayer film of the core is omitted. The whiter part corresponds to the parts with higher electric field intensity. It is understood from FIG. 6B that the two-dimensional waveguide mode is formed in which the electric field is concentrated in the regions having a larger core width in the opposing direction. Particularly in this example, because the periodic multilayer film is used as the core, it is understood as shown in FIG. 6B that the periodicity resonant waveguide mode is dominant in the waveguide mode, in which the fine fringe period in the opposing direction in the electric field intensity distribution is identical to the period of the periodic multilayer film. In addition, in the X-ray waveguide of this example, because the largest variation in the opposing direction between the region having a large core width and the region having a small core width is an integer multiple, the periodic resonant waveguide mode is formed in both regions, and the electric field intensity distribution thereof extends in both regions. Because such electromagnetic field distribution in the guiding cross section is formed by the interference of the X-rays over the entire core in the opposing direction and in the transverse direction, this waveguide mode are in phase over the entire core in the guiding cross section. By impinging the X-rays to the end surface parallel to the guiding cross section of the X-ray waveguide of this example so as to form an incident angle of approximately 0.3° with respect to the guiding direction in the plane perpendicular to the transverse direction, it is possible to excite a single two-dimensional waveguide mode having the electric field intensity distribution shown in FIG. 6B.

### Example 3

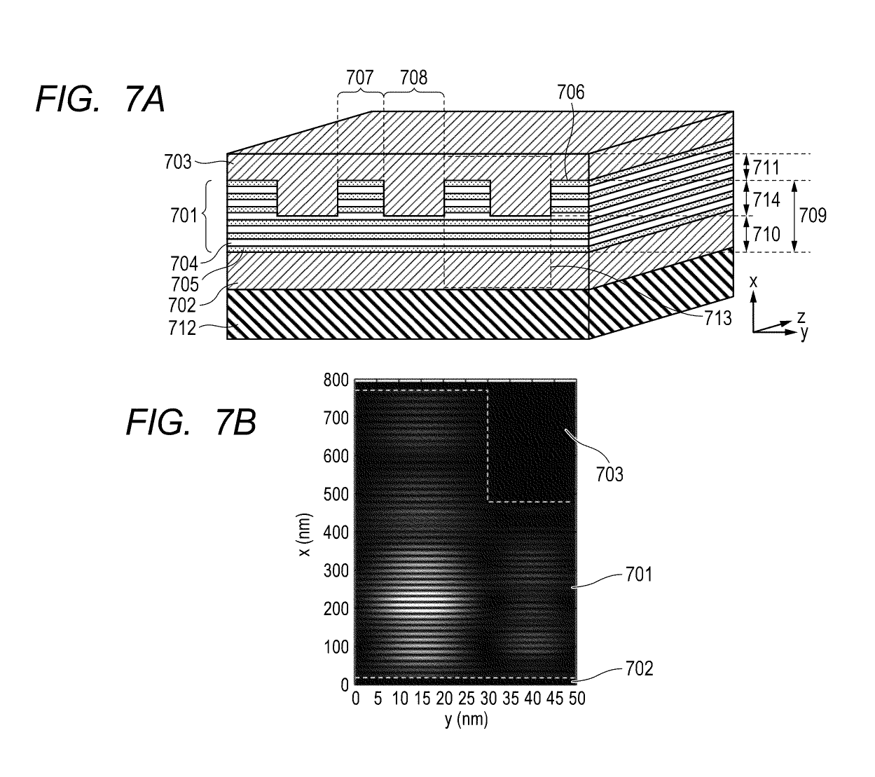

FIG. 7A is a perspective view illustrating an X-ray waveguide according to Example 3 of the present invention. In FIG. 7A, the guiding direction of an X-ray is the z direction, the opposing direction is the x direction, and the transverse direction is the y direction. This waveguide has a structure in which a lower clad 702 and an upper clad 703 that are made of tungsten (W) sandwiching a core 701, and is formed on a Si substrate 712. The interface 706 between the core 701 and the upper clad 703 has a one-dimensional periodic structure having a periodic relief in the transverse direction, and hence there are regions 707 having a large core width and a region 708 having a small core width in the opposing direction. The length of the X-ray waveguide of this example in the interface direction is so large as 10 mm, and hence only a part thereof is illustrated in FIG. 7A. The X-ray waveguide of this example has a structure in which tungsten (W) having a thickness of 20 nm is formed also at the edge in the transverse direction, and hence leakage of the X-ray in the transverse direction is suppressed. The core 701 is a periodic multilayer film in which high refractive index layers 704 that are made of boron carbide (B₄C) as a material having a large refractive index real part and has a thickness of 12 nm and low refractive index layers 705 that are made of aluminum oxide (Al₂O₃) as a material having a small refractive index real part and has a thickness of 3 nm are alternately periodically stacked. The period of the core 701 is 15 nm. The lengths of the region 707 and the region 708 in the transverse direction are 30 nm and 20 nm, respectively. In addition, in the opposing direction, the core width 709 in the region 707 corresponds to 50 periods of the periodic multilayer film, and a core width 710 in the region 708 corresponds to 29.5 periods of the periodic multilayer film. As a result, the largest variation 714 of the core width in the opposing direction in the region 707 and the region 708 corresponds to 20.5 periods of the periodic multilayer film, which is a positive half-integer multiple of the period. the thickness of the clad 711 at the region 706 is 20 nm. The X-ray waveguide of this example is obtained by forming the lower clad 702 that is made of tungsten (W) and has a thickness of 20 nm on a Si substrate 712 by a sputtering method, stacking the low refractive index layers 705 made of Al₂O₃ and the high refractive index layers 704 made of B₄C alternately for 50 periods, forming a periodic relief structure in the transverse direction on a surface of the core by electron beam lithography and dry etching process, and forming the upper clad 703 made of W on the periodic relief structure by sputtering.

FIG. 7B is a graph showing the electric field intensity distribution in the guiding cross section in the waveguide mode formed in the X-ray waveguide of this example, which is obtained by calculation for the X-rays having a photon energy of 8 kilo electron volts. The X-ray waveguide of this example has periodicity in the transverse direction, and therefore only a region corresponding to a unit lattice thereof, for example, a region 713 is shown in FIG. 7B. The white broken lines in FIG. 7B indicate the core-clad boundaries in the waveguide structure in the guiding cross section, and the gradation of white and black indicates the electric field intensity distribution. Note that, in order to avoid obscurity in the graph, the boundaries of the materials in the periodic multilayer film of the core is omitted. The whiter parts correspond to the parts with higher electric field intensity. It is understood from FIG. 7B that there is formed the two-dimensional waveguide mode in which the electric field is concentrated in the regions having a larger core width in the opposing direction. Particularly in this example, because the periodic multilayer film is used as the core, it is understood as shown in FIG. 7B that the periodicity resonant waveguide mode is dominant in the waveguide mode, in which the fine fringe period in the opposing direction in the electric field intensity distribution is identical to the period of the periodic multilayer film. In addition, in the X-ray waveguide of this example, the largest variation of the core width in the opposing direction between the region having a large core width and the region having a small core width is a positive half-integer multiple, and the two-dimensional periodicity resonant waveguide mode is formed locally in the region 707 having a thickness of an integer multiple of the period in the opposing direction. In the guiding cross section, there are parts in which the electric field is concentrated and parts in which the electric field is not concentrated. However, because this distribution is formed by the interference of the X-rays over the entire core in the opposing direction and in the transverse direction, this waveguide mode are in phase over the entire core in the guiding cross section. By impinging the X-rays at the end surface parallel to the guiding cross section of the X-ray waveguide of this example so as to form an incident angle of approximately 0.3° with respect to the guiding direction in the plane perpendicular to the transverse direction, it is possible to excite a single two-dimensional waveguide mode having the electric field intensity distribution shown in FIG. 7B.

### Example 4

An X-ray waveguide according to Example 4 of the present invention is obtained by replacing the periodic multilayer film as the core of the X-ray waveguide described above in Example 3 with a mesostructured material having a lamellar structure. The mesostructured materials having the lamellar structure forming the core of the X-ray waveguide of this example is formed on a clad made of tungsten formed on a silicon substrate, in which an organic substance layers that have a large refractive index real part and has a thickness of approximately 7.7 nm and a silica layers that have a small refractive index real part and has a thickness of approximately 3.3 nm are alternately formed. The mesostructured material gives a one-dimensional periodic refractive index distribution in the direction perpendicular to the interface between the core and the clad. The one-dimensional periodic structure is formed on the core surface in the transverse direction similarly to Example 3, by performing electron beam lithography and dry etching on the mesostructured material. Further, a film of tungsten is formed as the upper clad on the one-dimensional periodic structure by a sputtering method, so as to form the X-ray waveguide of this example. The period of the mesostructured material having the lamellar structure is approximately 11 nm. The number of the period in the region having a wide core is 50 and the number of the period in the region having a narrow core is 29.5 in the opposing direction. The mesostructured material having a lamellar structure of this example is formed by a dip coating method using a precursor solution prepared by adding an inorganic oxide precursor to a solution of a surfactant, whose assembly works as a template. In this case, a block polymer and tetraethoxysilane are used as the surfactant and the inorganic oxide precursor, respectively. The precursor solution is prepared by, using ethanol as a solvent, adding water and hydrochloric acid for performing hydrolysis of tetraethoxysilane to a solution prepared by adding tetraethoxysilane to the solution of the block polymer, and stirring the mixture. Tetraethoxysilane, a block polymer, water, hydrochloric acid, and ethanol are mixed at a ratio (molar ratio) of 1:0.0264:8:0.01:40. A polyethylene glycol (20)-polypropylene glycol (70)-polyethylene glycol (20) triblock copolymer is used as the block polymer (number in parentheses is a repetition number of the block). The mesostructured material having a lamellar structure is formed by a self-assembly process in the course of evaporation of the solvent of the solution. By impinging X-rays at the end surface parallel to the guiding cross section of the X-ray waveguide of this example so as to form an incident angle of approximately 0.44° with respect to the guiding direction in the plane perpendicular to the transverse direction, it is possible to form a two-dimensional periodicity resonant waveguide mode by the same principle as Example 3.

### Example 5

An X-ray waveguide according to Example 5 of the present invention is obtained by replacing the periodic multilayer film as the core of the X-ray waveguide described above in Example 2 with a mesostructured material, which is a mesoporous material. The mesoporous material forming the core of the X-ray waveguide of this example is a mesoporous silica having multiple pores with a uniform diameter in silica. The cross section of the mesoporous silica perpendicular to the guiding direction has a two-dimensional periodic structure. Layers of air-dominant portions and layers of silica-dominant portions are alternately formed in the opposing direction to have such a refractive index distribution that the average refractive index is periodically changed in that direction. In other words, in the opposing direction, the mesoporous silica has a one-dimensional periodic structure with a period of approximately 10 nm. The number of the period in the region having a wide core is 50 and the number of the period in the region having a narrow region is 30 in the opposing direction. The precursor solution of the mesoporous silica is prepared according to the method described above in Example 4, tetraethoxysilane, a block polymer, water, hydrochloric acid, and ethanol are mixed at a ratio (molar ratio) of 1:0.0096:8:0.01:40. This solution is put on the upper part of the lower clad made of tungsten, and is dried and aged, followed by dipping in a solvent. Thus, a block copolymer as a template is extracted to be removed so that a mesoporous silica film is prepared. Mesoporous film with hollow pores, which is obtained by the template removal process, particularly reduces the propagation loss of the X-rays. The core of the X-ray waveguide of this example is a mesoporous silica film in which the organic substance used for the template is removed from the pores by the removal process. By impinging X-rays having a photon energy of 10 kilo electron volts at the end surface parallel to the guiding cross section of the X-ray waveguide of this example so as to form an incident angle of approximately 0.36° with respect to the guiding direction in the plane perpendicular to the transverse direction, it is possible to form a two-dimensional periodicity resonant waveguide mode by the same principle as that in Example 2.

The present invention can provide an X-ray waveguide having a wide core, which can realize an X-ray beam having high two-dimensional spatial coherence whose mode is controlled in the two-dimensional direction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-063598, filed Mar. 26, 2013, which is hereby incorporated by reference herein in its entirety.

What is claimed is:

1. An X-ray waveguide, comprising:
a core; and
two clads opposing to each other so as to sandwich the core,
wherein one of the interfaces between the clad and the core has a periodic relief structure in a direction perpendicular to an opposing direction of the two clads and perpendicular to a guiding direction of an X-ray in the X-ray waveguide.

2. An X-ray waveguide according to claim 1, wherein the periodic relief structure comprises a one-dimensional periodic structure.

3. An X-ray waveguide according to claim 2, wherein when the thickness of the core in the opposing direction in a region having a relatively large thickness is taken to be 1, the thickness of the core in the opposing direction in a region having a relatively small thickness is 1/e² or larger and 1−1/e² or smaller, where e is Napier's constant.

4. An X-ray waveguide according to claim 1, wherein the core has a periodic structure in the opposing direction.

5. An X-ray waveguide according to claim 4, wherein the Bragg angle defined by the periodic structure of the core and a wavelength of the X-ray is smaller than the total reflection critical angle of the X-ray at the interface between the core and the one of the two clads.

6. An X-ray waveguide according to claim 4, wherein the core has a one-dimensional periodic structure in the opposing direction.

7. An X-ray waveguide according to claim 6, wherein a top-to-bottom difference of the interface in the opposing direction is one of a natural-number multiple and a half-integer multiple of a period of the one-dimensional periodic structure of the core.

8. An X-ray waveguide according to claim 6, wherein the one-dimensional periodic structure of the core in the opposing direction comprises a periodic multilayer film.

9. An X-ray waveguide according to claim 8, wherein the periodic multilayer film comprises a mesostructured material having a lamellar structure.

10. An X-ray waveguide according to claim 6, wherein the one-dimensional periodic structure of the core in the opposing direction comprises a mesostructured material which is a mesoporous material.

11. An X-ray waveguide according to claim 1, wherein a period of the periodic relief structure of the interface is 1 nm or larger and 10 μm or smaller.
